(19) United States
(12) Patent Application Publication
(10) Pub. No.: US 2023/0263357 A1
(43) Pub. Date: Aug. 24, 2023

(54) RINSE CONTROL METHOD AND APPARATUS FOR CLEANING MECHANISM, AND STORAGE MEDIUM

(71) Applicant: Dreame Innovation Technology (Suzhou) Co., LTD., Suzhou City, Jiangsu Province (CN)

(72) Inventor: SHENGLE WANG, Suzhou City, Jiangsu Province (CN)

(21) Appl. No.: 18/012,225

(22) PCT Filed: Jun. 8, 2021
(86) PCT No.: PCT/CN2021/098769

§ 371 Date: Dec. 21, 2022

(30) Foreign Application Priority Data
Jun. 23, 2020 (CN) 202010577982.6

(51) Int. Cl. A47L 11/40; B08B 1/00

(52) U.S. Cl. CPC A47L 11/4011; B08B 1/007; A47L 2201/06; A47L 11/4005

(57) ABSTRACT

A cleaning mechanism is installed on a cleaning device. The cleaning mechanism is used to clean a work area under control of the cleaning device. A cleaning control method for the cleaning mechanism includes: obtaining a cleaning start time of the cleaning device; obtaining a cleaning duration of the cleaning mechanism; determining a cleaning time of the cleaning mechanism based on the cleaning start time and the cleaning duration, the cleaning time being before the cleaning start time; and controlling the cleaning device to clean the cleaning mechanism when the time reaches the cleaning time. A cleaning control apparatus and a computer-readable storage medium are also disclosed.

### TECHNICAL FIELD

Embodiments of the present specification relate to a cleaning control method, an apparatus and a storage medium for a cleaning mechanism, which belongs to a field of computer technologies.

### BACKGROUND

Cleaning devices (such as sweeping robots, mopping robots, etc.,) are a type of smart household appliances. It can automatically complete a floor cleaning work in a room with a certain artificial intelligence. In the existing cleaning devices, the mopping function is realized by arranging a rag at a bottom of the device. When the rag is seriously dirty, it will cause secondary pollution to the ground in a subsequent ground cleaning process. Therefore, a cleaning mechanism (e.g., a mop) needs to be cleaned before the cleaning device starts to work.

A cleaning control method for the existing cleaning mechanism includes: firstly cleaning the cleaning mechanism when the cleaning device receives a signal to start working; and cleaning the work area after cleaning the cleaning mechanism.

However, cleaning the cleaning mechanism only when starting to work will cause a delay in the starting time of the cleaning device and reduce the cleaning efficiency of the cleaning device.

### SUMMARY

The embodiments of the present specification provide a cleaning control method, an apparatus and a storage medium for a cleaning mechanism, the problem that the cleaning mechanism is cleaned only when starting to work, resulting in low cleaning efficiency of the cleaning device can be solved. The embodiments of the present specification provide the following technical solutions:

In a first aspect, a cleaning control method for a cleaning mechanism is provided. The cleaning mechanism is installed on a cleaning device. The cleaning mechanism is used to clean a work area under control of the cleaning device. The method includes:

obtaining a cleaning start time of the cleaning device;

obtaining a cleaning duration of the cleaning mechanism;

determining a cleaning time of the cleaning mechanism based on the cleaning start time and the cleaning duration, the cleaning time being before the cleaning start time; and

controlling the cleaning device to clean the cleaning mechanism when the time reaches the cleaning time.

Alternatively, obtaining the cleaning start time of the cleaning device, includes:

receiving the cleaning start time sent by another device, the another device being communicatively connected with the cleaning device, and a receiving time that receives the cleaning start time is before the cleaning start time.

Alternatively, obtaining the cleaning start time of the cleaning device, includes:

obtaining a historical cleaning start time of the cleaning device; and

predicting the cleaning start time based on the historical cleaning start time.

Alternatively, predicting the cleaning start time based on the historical cleaning start time, includes:

when there are more than a preset number of historical cleaning start times within a same time range, determining the cleaning start time according to a plurality of the historical cleaning start times within the time range.

Alternatively, obtaining the cleaning duration of the cleaning mechanism, includes:

obtaining a historical cleaning duration of the cleaning mechanism; and

predicting the cleaning duration this time according to the historical cleaning duration.

Alternatively, obtaining the cleaning duration of the cleaning mechanism, includes:

obtaining a degree of contamination of the cleaning mechanism; and

determining the cleaning duration this time according to the degree of contamination.

Alternatively, obtaining the degree of contamination of the cleaning mechanism, includes:

obtaining a last working duration of the cleaning device; and

determining the degree of contamination according to the working duration, and the working duration being positively correlated with the degree of contamination.

Alternatively, the method further includes:

determining whether the cleaning mechanism is cleaned after a last work; and

triggering to execute a step of determining the cleaning time of the cleaning mechanism based on the cleaning start time and the cleaning duration, when the cleaning mechanism is not cleaned.

In a second aspect, a cleaning control apparatus of a cleaning mechanism is provided. The cleaning mechanism is installed on a cleaning device. The cleaning mechanism is used to clean a work area under control of the cleaning device. The apparatus includes:

a time obtaining module, configured for obtaining a cleaning start time of the cleaning device;

a duration obtaining module, configured for obtaining a cleaning duration of the cleaning mechanism;

a time determination module, configured for determining a cleaning time of the cleaning mechanism based on the cleaning start time and the cleaning duration, the cleaning time being before the cleaning start time; and

a cleaning control module, configured for controlling the cleaning device to clean the cleaning mechanism when the time reaches the cleaning time.

In a third aspect, a cleaning control apparatus for a cleaning mechanism is provided, wherein the apparatus includes a processor and a memory, a program is stored in the memory, and the program is loaded and executed by the processor to implement the cleaning control method for the cleaning mechanism according to the first aspect.

In a fourth aspect, a computer-readable storage medium is provided, wherein a program is stored in the storage medium, and the program is used to implement the cleaning control method for the cleaning mechanism according to the first aspect when the program is executed by the processor.

The beneficial effects of the embodiments of the present specification are: by obtaining a cleaning start time of the cleaning device; obtaining a cleaning duration of the cleaning mechanism; determining a cleaning time of the cleaning mechanism based on the cleaning start time and the cleaning duration, the cleaning time being before the cleaning start time; and controlling the cleaning device to clean the cleaning mechanism when the time reaches the cleaning time, the problem that the cleaning mechanism is cleaned only when starting to work, resulting in low cleaning efficiency of the cleaning device can be solved. Since the cleaning mechanism can be cleaned before starting the work, the cleaning efficiency of the cleaning device can be improved.

The above description is only an overview of the technical solutions of the embodiments of the present specification. In order to have a clearer understanding of the technical means of the embodiments of the present specification and to implement them in accordance with the contents of the present specification, the preferred embodiments of the present specification and the accompanying drawings are described in detail below.

### BRIEF DESCRIPTION OF DRAWINGS

In order to more clearly illustrate the technical solutions in the embodiments of the present specification or in the prior art, the accompanying drawings required to be used in the description of the embodiments or the prior art will be briefly introduced below. Obviously, the drawings in the following description are only some embodiments described in this specification, and for those of ordinary skill in the art, other drawings can also be obtained from these drawings without creative effort.

FIG. 1 is a schematic structural diagram of a cleaning device provided by an embodiment of the present specification;

FIG. 2 is a flowchart of a cleaning control method for a cleaning mechanism provided by an embodiment of the present specification;

FIG. 3 is a block diagram of a cleaning control apparatus of a cleaning mechanism provided by an embodiment of the present specification; and

FIG. 4 is another block diagram of a cleaning control apparatus of a cleaning mechanism provided by an embodiment of the present specification.

### DETAILED DESCRIPTION

The specific implementations of the embodiments of the present specification will be described in further detail below with reference to the accompanying drawings and embodiments. The following examples are used to illustrate the present specification, but are not intended to limit the scope of the embodiments of the present specification.

FIG. 1 is a schematic structural diagram of a cleaning device provided in an embodiment of the present specification. The cleaning device is a device with a cleaning function and a self-moving function, such as a sweeping robot, a mopping robot, etc., and a device type of the cleaning device is not limited in this embodiment. As shown in FIG. 1, the cleaning device at least includes: a cleaning mechanism 110 and a control component 120.

Among them, the cleaning mechanism 110 is used to clean the work area under the control of the cleaning device. Alternatively, the cleaning mechanism 110 may be a brush, a rag, or the like, and the type of the cleaning mechanism 110 is not limited in this embodiment.

The control component 120 is used to control the operation of the cleaning device, such as: controlling the time when the cleaning device starts to work, the time when the cleaning device ends, and controlling the cleaning of the cleaning mechanism, etc.

In this embodiment, the control component 120 is configured for: obtaining a cleaning start time of the cleaning device; obtaining a cleaning duration of the cleaning mechanism; determining a cleaning time of the cleaning mechanism based on the cleaning start time and the cleaning duration, the cleaning time being before the cleaning start time; and controlling the cleaning device to clean the cleaning mechanism when the time reaches the cleaning time.

In addition, in this embodiment, the control component 120 is installed on the cleaning device as an example for description. In actual implementation, the control component 120 may also be installed in other devices independent of the cleaning device.

In addition, the cleaning device may also include more components, such as: a moving component (e.g., a wheel) for driving the cleaning device to move, a driving component (e.g., a motor) for driving the moving component, and a power supply component (e.g., a battery pack). In this embodiment, the components included in the cleaning device are not listed one by one.

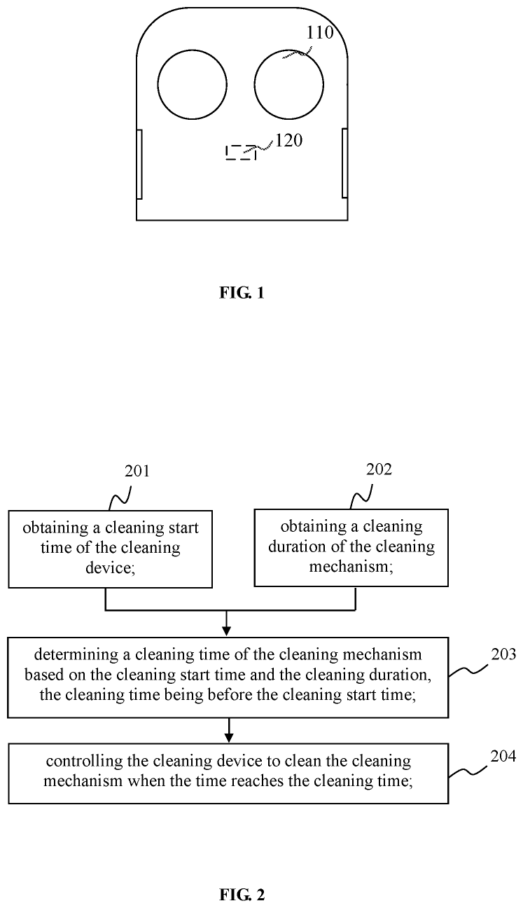

FIG. 2 is a flowchart of a cleaning control method for a cleaning mechanism provided by an embodiment of the present specification. This embodiment is described by taking the method applied to the cleaning device shown in FIG. 1, and an execution subject of each step being the control component 120 as an example. The method includes at least the following steps:

step 201, obtaining a cleaning start time of the cleaning device.

Alternatively, the manner of obtaining the cleaning start time of the cleaning device includes but is not limited to at least one of the following manners:

A first manner: receiving the cleaning start time sent by another device, wherein a receiving time that receives the cleaning start time is before the cleaning start time.

The another device is communicatively connected with the cleaning device. The another device may be a terminal with a device control program installed therein. The device control program is used for a user to control the cleaning device. The terminal may be a mobile phone, a tablet computer, a wearable device, etc., and the type of the terminal is not limited in this embodiment.

A second manner: obtaining a historical cleaning start time of the cleaning device; and predicting the cleaning start time according to the historical cleaning start time.

In an example, predicting the cleaning start time based on the historical cleaning start time, includes: when there are more than a preset number of historical cleaning start times within a same time range, determining the cleaning start time according to a plurality of the historical cleaning start times within the time range.

For example, the average of the plurality of the historical cleaning start times within the time range is calculated to get the cleaning start time.

For another example: a corresponding weight is assigned according to the number of times of each historical cleaning start time, and a weighted average of the plurality of the historical cleaning start times is calculated to get the cleaning start time. Wherein the number of times and the weight are positively correlated.

Of course, the cleaning start time may also be determined in other manners according to the plurality of the historical cleaning start times within the same time range, which will not be listed one by one in this embodiment.

The preset number may be five, ten, etc., and this embodiment does not limit the value of the preset number.

The time range spans less than twenty four hours. For example, the span of the time range is half an hour, one hour, ten minutes, etc. This embodiment does not limit the setting method of the time range.

In another example, the cleaning device determines the last cleaning start time as the current cleaning start time. Of course, the cleaning device may also use other methods to predict the cleaning start time according to the historical cleaning start time, which will not be listed one by one in this embodiment.

step 202, obtaining a cleaning duration of the cleaning mechanism.

Wherein obtaining the cleaning duration of the cleaning mechanism includes but is not limited to the following manners:

A first manner: obtaining a historical cleaning duration of the cleaning mechanism; and predicting the cleaning duration this time according to the historical cleaning duration.

For example, the average value of each historical cleaning duration is determined as the cleaning duration this time.

A second manner: obtaining a degree of contamination of the cleaning mechanism; and determining the cleaning time according to the degree of contamination.

Alternatively, obtaining the degree of contamination of the cleaning mechanism, includes: obtaining the last working time of the cleaning device; and determining the degree of the contamination according to the working time. Wherein the working time is positively correlated with the degree of contamination. Alternatively, a contamination detection sensor is installed on the cleaning device, and the degree of contamination of the cleaning mechanism is determined by the detection result of the contamination detection sensor. The contamination detection sensor may be an image sensor.

Wherein determining the cleaning time according to the degree of contamination, includes: establishing a mapping relationship between the degree of contamination and the cleaning duration. The cleaning duration corresponding to the current degree of contamination of the cleaning mechanism is determined according to the mapping relationship.

Alternatively, the step 202 may be performed after the step 201; or may be performed before the step 201; or may also be performed simultaneously with the step 201. The present embodiment does not limit an execution order between the step 201 and the step 202.

step 203: determining a cleaning time of the cleaning mechanism based on the cleaning start time and the cleaning duration, where the cleaning time is before the cleaning start time.

Alternatively, the cleaning time is before a time obtained by subtracting the cleaning duration from the cleaning start time; or the cleaning time is a time obtained by subtracting the cleaning duration from the cleaning start time.

Since the cleaning device may have cleaned the cleaning mechanism after the last cleaning work was completed. Therefore, in order to avoid the problem of repeated cleaning, in this embodiment, the cleaning device will determine whether to clean the cleaning mechanism after the last work. The step 203 is performed when the cleaning mechanism is not cleaned.

step 204, controlling the cleaning device to clean the cleaning mechanism when the time reaches the cleaning time.

In an example, the cleaning device does not carry a water tank. At this time, controlling the cleaning device to clean the cleaning mechanism, includes: controlling the cleaning device to move to a position of the water tank, so that the cleaning device at the position of the water tank cleans the cleaning mechanism.

In another example, a water tank is carried on the cleaning device. At this time, controlling the cleaning device to clean the cleaning mechanism, includes: controlling a water pumping device to pump the water from the water tank, and spraying the pumped water to clean the cleaning mechanism.

In summary, according to the cleaning control method of the cleaning mechanism provided in this embodiment, by obtaining the cleaning start time of the cleaning device; obtaining the cleaning duration of the cleaning mechanism; determining the cleaning time of the cleaning mechanism based on the cleaning start time and the cleaning duration, the cleaning time being before the cleaning start time; and controlling the cleaning device to clean the cleaning mechanism when the time reaches the cleaning time, the problem that the cleaning mechanism is cleaned only when starting to work, resulting in low cleaning efficiency of the cleaning device can be solved. Since the cleaning mechanism can be cleaned before starting the work, the cleaning efficiency of the cleaning device can be improved.

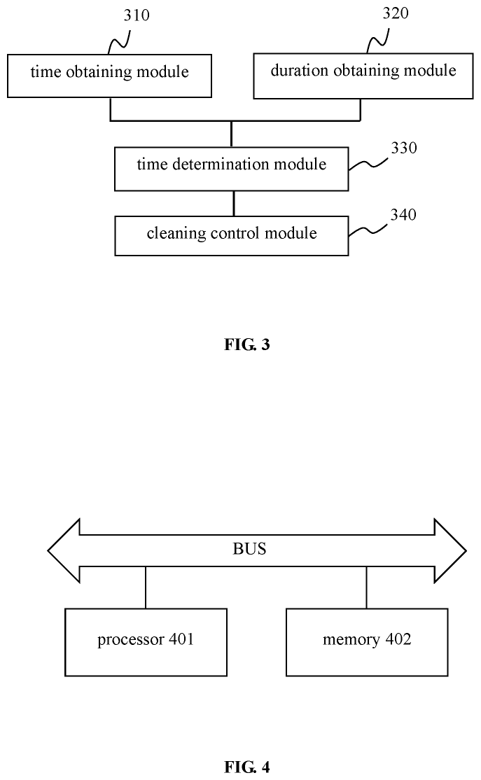

FIG. 3 is a block diagram of a cleaning control apparatus of a cleaning mechanism provided by an embodiment of the present specification. This embodiment is described by taking the apparatus applied to the cleaning device shown in FIG. 1 as an example. The apparatus includes at least the following modules: a time obtaining module 310, a duration obtaining module 320, a time determination module 330 and a cleaning control module 340.

The time obtaining module 310 is configured for obtaining a cleaning start time of the cleaning device.

The duration obtaining module 320 is configured for obtaining a cleaning duration of the cleaning mechanism.

The time determination module 330 is configured for determining a cleaning time of the cleaning mechanism based on the cleaning start time and the cleaning duration. The cleaning time is before the cleaning start time.

The cleaning control module 340 is configured for controlling the cleaning device to clean the cleaning mechanism when the time reaches the cleaning time.

For relevant details, refer to the above method embodiments.

It should be noted that when the cleaning control apparatus for the cleaning mechanism provided in the above embodiment performs cleaning control of the cleaning mechanism, only the division of the above-mentioned functional modules is used as an example for illustration. In practical applications, the above-mentioned functions can be assigned to different function modules as required. That is, the internal structure of the cleaning control apparatus of the cleaning mechanism is divided into different functional modules to complete all or part of the functions described above. In addition, the cleaning control apparatus for a cleaning mechanism provided in the above embodiments and the cleaning control method for a cleaning mechanism belong to the same concept, and the specific implementation process is detailed in the method embodiment, which will not be repeated here.

FIG. 4 is a block diagram of a cleaning control apparatus of a cleaning mechanism provided by an embodiment of the present specification. The apparatus may be the cleaning device shown in FIG. 1. The apparatus includes at least a processor 401 and a memory 402.

The processor 401 may include one or more processing cores, such as a 4-core processor, an 8-core processor, and the like. The processor 401 may be implemented in at least one hardware form among DSP (Digital Signal Processing), FPGA (Field-Programmable Gate Array), and PLA (Programmable Logic Array). The processor 401 may also include a main processor and a co-processor. The main processor is a processor for processing data in a wake-up state, and is also called a CPU (Central Processing Unit). The co-processor is a low-power processor for processing data in a standby state. In some embodiments, the processor 401 may be integrated with a GPU (Graphics Processing Unit). The GPU is responsible for rendering and drawing what the display needs to display. In some embodiments, the processor 401 may further include an AI (Artificial Intelligence) processor. This AI processor is used to process computing operations related to machine learning.

The memory 402 may include one or more computer-readable storage medium. The computer-readable storage medium may be non-transitory. The memory 402 may also include high-speed random access memory, as well as non-volatile memory, such as one or more disk storage devices, flash storage devices. In some embodiments, a non-transitory computer-readable storage medium in the memory 402 is used to store at least one instruction. The at least one instruction is used to be executed by the processor 401 to implement the cleaning control method for the cleaning mechanism provided by the embodiments of this specification.

In some embodiments, the cleaning control apparatus of the cleaning mechanism may also alternatively include: a peripheral device port and at least one peripheral device. The processor 401, the memory 402 and the peripheral device port can be connected through a BUS or a signal line. Each peripheral device can be connected to the peripheral device port through the BUS, the signal line or a circuit board. Illustratively, the peripheral devices include, but are not limited to, radio frequency circuits, power supplies, and the like.

Of course, the cleaning control apparatus of the cleaning mechanism may also include fewer or more components, which is not limited in this embodiment.

Alternatively, the embodiment of this specification further provides a computer-readable storage medium. A program is stored in the computer-readable storage medium. The program is loaded and executed by the processor to implement the cleaning control method of the cleaning mechanism of the above method embodiment.

Alternatively, the embodiment of the present specification further provides a computer product. The computer product includes a computer-readable storage medium. A program is stored in the computer-readable storage medium. The program is loaded and executed by the processor to implement the cleaning control method of the cleaning mechanism of the above method embodiment.

The technical features of the above-described embodiments can be combined arbitrarily. In order to simplify the description, all possible combinations of the technical features in the above embodiments are not described. However, as long as there is no contradiction in the combination of these technical features, they should be considered to be within the scope of the description in this specification.

The above-mentioned embodiments only represent several implementations of the embodiments of the present specification, and the descriptions thereof are relatively specific and detailed, but should not be construed as a limitation on the scope of the patent application. It should be noted that, for those skilled in the art, some modifications and improvements can be made without departing from the concept of the embodiments of the present specification. These all belong to the protection scope of the embodiments of the present specification. Therefore, the protection scope of the embodiments of the present specification should be governed by the appended claims.

1. A cleaning control method for a cleaning mechanism, the cleaning mechanism being installed on a cleaning device, the cleaning mechanism being used to clean a work area under control of the cleaning device, the method comprising:
obtaining a cleaning start time of the cleaning device;
obtaining a cleaning duration of the cleaning mechanism;
determining a cleaning time of the cleaning mechanism based on the cleaning start time and the cleaning duration, the cleaning time being before the cleaning start time; and
controlling the cleaning device to clean the cleaning mechanism when the time reaches the cleaning time.

2. The method according to claim 1, wherein obtaining the cleaning start time of the cleaning device, comprises:
receiving the cleaning start time sent by another device, the another device being communicatively connected with the cleaning device, and a receiving time that receives the cleaning start time is before the cleaning start time.

3. The method according to claim 1, wherein obtaining the cleaning start time of the cleaning device, comprises:
obtaining a historical cleaning start time of the cleaning device; and
predicting the cleaning start time based on the historical cleaning start time.

4. The method according to claim 3, wherein predicting the cleaning start time based on the historical cleaning start time, comprises:
when there are more than a preset number of historical cleaning start times within a same time range, determining the cleaning start time according to a plurality of the historical cleaning start times within the time range.

5. The method according to claim 1, wherein obtaining the cleaning duration of the cleaning mechanism, comprises:
obtaining a historical cleaning duration of the cleaning mechanism; and
predicting the cleaning duration this time according to the historical cleaning duration.

6. The method according to claim 1, wherein obtaining the cleaning duration of the cleaning mechanism, comprises:
obtaining a degree of contamination of the cleaning mechanism; and
determining the cleaning duration this time according to the degree of contamination.

7. The method according to claim 6, wherein obtaining the degree of contamination of the cleaning mechanism, comprises:
obtaining a last working duration of the cleaning device; and
determining the degree of contamination according to the working duration, and the working duration being positively correlated with the degree of contamination.

8. The method according to claim 1, further comprising:
determining whether the cleaning mechanism is cleaned after a last work; and
triggering to execute a step of determining the cleaning time of the cleaning mechanism based on the cleaning start time and the cleaning duration, when the cleaning mechanism is not cleaned.

9. A cleaning control apparatus for a cleaning mechanism, wherein the apparatus comprises a processor and a memory, a program is stored in the memory, and the program is loaded and executed by the processor to implement a cleaning control method for the cleaning mechanism, the cleaning mechanism being installed on a cleaning device, the cleaning mechanism being used to clean a work area under control of the cleaning device, the cleaning control method comprising:
obtaining a cleaning start time of the cleaning device;
obtaining a cleaning duration of the cleaning mechanism;
determining a cleaning time of the cleaning mechanism based on the cleaning start time and the cleaning duration, the cleaning time being before the cleaning start time; and
controlling the cleaning device to clean the cleaning mechanism when the time reaches the cleaning time.

10. A computer-readable storage medium, wherein a program is stored in the storage medium, and the program is used to implement a cleaning control method for the cleaning mechanism when the program is executed by the processor, the cleaning mechanism being installed on a cleaning device, the cleaning mechanism being used to clean a work area under control of the cleaning device, the cleaning control method comprising:
obtaining a cleaning start time of the cleaning device;
obtaining a cleaning duration of the cleaning mechanism;
determining a cleaning time of the cleaning mechanism based on the cleaning start time and the cleaning duration, the cleaning time being before the cleaning start time; and
controlling the cleaning device to clean the cleaning mechanism when the time reaches the cleaning time.

11. The method according to claim 4, wherein when there are more than the preset number of historical cleaning start times within the same time range, determining the cleaning start time according to the plurality of the historical cleaning start times within the time range, comprises:
calculating an average value of the plurality of the historical cleaning start times within the time range to obtain the cleaning start time.

12. The method according to claim 4, wherein when there are more than the preset number of historical cleaning start times within the same time range, determining the cleaning start time according to the plurality of the historical cleaning start times within the time range, comprises:
assigning a corresponding weight to the number of times of each historical cleaning start time, and calculating a weighted average value of the plurality of the historical cleaning start times to obtain the cleaning start time; wherein the number of times and the weight are positively correlated.

13. The method according to claim 3, wherein predicting the cleaning start time based on the historical cleaning start time, comprises:
determining the cleaning start time last time of the cleaning device as a current cleaning start time.

14. The method according to claim 5, wherein obtaining the historical cleaning duration of the cleaning mechanism, comprises:
determining an average value of the historical cleaning durations as the cleaning duration this time.

15. The method according to claim 6, wherein obtaining the degree of contamination of the cleaning mechanism, comprises:
determining the degree of contamination of the cleaning mechanism by a detection result of a contamination detection sensor which is installed on the cleaning device.

16. The method according to claim 6, wherein determining the cleaning duration this time according to the degree of contamination, comprises:
establishing a mapping relationship between the degree of contamination and the cleaning duration; and determining the cleaning duration corresponding to a current degree of contamination of the cleaning mechanism according to the mapping relationship.

17. The method according to claim 1, wherein the cleaning time is before a time obtained by subtracting the cleaning duration from the cleaning start time; or
the cleaning time is a time obtained by subtracting the cleaning duration from the cleaning start time.

18. The method according to claim 1, wherein when the cleaning device does not carry a water tank, controlling the cleaning device to clean the cleaning mechanism when the time reaches the cleaning time, comprises:
controlling the cleaning device to move to a position of the water tank, so that the cleaning device at the position of the water tank cleans the cleaning mechanism.

19. The method according to claim 1, wherein when a water tank is carried on the cleaning device, controlling the cleaning device to clean the cleaning mechanism when the time reaches the cleaning time, comprises:
controlling a water pumping device to pump the water from the water tank, and spraying the pumped water to clean the cleaning mechanism.

20. The cleaning control apparatus according to claim 9, wherein the memory stores following program modules:
a time obtaining module, configured for obtaining a cleaning start time of the cleaning device;
a duration obtaining module, configured for obtaining a cleaning duration of the cleaning mechanism;
a time determination module, configured for determining a cleaning time of the cleaning mechanism based on the cleaning start time and the cleaning duration, the cleaning time being before the cleaning start time; and
a cleaning control module, configured for controlling the cleaning device to clean the cleaning mechanism when the time reaches the cleaning time.
